(19) United States
(12) Patent Application Publication
(10) Pub. No.: US 2010/0314271 A1
(43) Pub. Date: Dec. 16, 2010

(54) PORTABLE FOLDABLE MULTI CARRIAGE DEVICE

(76) Inventor: Erez Baruch, Rehovot (IL)

Correspondence Address: Erez Baruch, 16 Habrigada Street, Rehovot, 76228, omitted

(21) Appl. No.: 12/794,793

(22) Filed: Jun. 7, 2010

(30) Foreign Application Priority Data
Jun. 10, 2009 (IL) 199266

(51) Int. Cl. B65D 85/00; A47B 46/00

(52) U.S. Cl. 206/349; 312/249.1

(57) ABSTRACT

A portable foldable multi carriage device that enable achieving large lateral gaps between carriages and enable modes of opening in which the carriages are not parallel, the portable foldable multi carriage device including a pair of first support members, wherein each of the first support members has two ends, a pair of second support members, wherein each of the second support members has two free ends, and a long shaft, wherein the pair of first support members is mounted on the long shaft and wherein the pair of second support members is mounted on the long shaft, having a rotational capability with regard to each other, the long shaft being the center of the rotation.

### REFERENCE TO CROSS-RELATED APPLICATION

This application claims priority to Israeli patent application No. 199,266, filed on Jun. 10, 2009, herein incorporated by reference in its entirety.

### FIELD OF THE INVENTION

The present invention relates to multi carriages devices, more particularly, to portable foldable multi carriages devices.

### BACKGROUND OF THE INVENTION

There are various known devices which enable porting tiers of carriages from one place to another. These devices are folded for porting and/or storage, and prior to use or positioning where they are required, they are opened. There is a wide variety of carriage devices, also including shelves, such as bookshelves, and boxes, such as toolboxes. These devices typically include pairs of support rods and open to a structure with multiple parallel tiers.

FIG. 1 of the prior art is a side view schematic illustration of two typical multi carriage devices, serving as sewing kits 10. The left-hand sewing kit 10 is closed, while the right-hand sewing kit 10 is in an open mode, which can be referred to as working mode. Each of both sewing kits 10 as shown in the present illustration, includes three trays 11 which are connected by means of pivots 13 to three pairs of parallel link members 12.

One pair, the central one in the side view, is longer, while the other two pairs are shorter. The side view shows only one link member 12 of each pair. This typical structure significantly limits the lateral gap between the trays 11 when opening and keeps them parallel in any state, from closed mode, through transitional modes, to fully open mode. These limits sometimes make it impossible to load or unload the trays 11 with objects of various shapes and sizes.

There is therefore a need for a portable foldable multi carriage device that will enable achieving large lateral gaps between carriages and enable modes of opening in which the carriages are not parallel.

### SUMMARY OF THE INVENTION

According to an embodiment of the present invention there is provided a portable foldable multi carriage device including: a pair of first support members, wherein each of the first support members has two ends; a pair of second support members, wherein each of the second support members has two free ends; and a long shaft, wherein the pair of first support members is mounted on the long shaft, wherein the pair of second support members is mounted on the long shaft, having a rotational capability with regard to each other and wherein the long shaft is a center of the rotation, and wherein the portable foldable multi carriage device has a folded state and open state.

According to further features of the described embodiment of the present invention the center of rotation is practically located at a center of each of the second support members.

According to still further features of the described embodiment of the present invention, the portable foldable multi carriage device further includes: at least two toolboxes wherein each of the toolboxes has a topside and an underside; and at least four short shaft, wherein each of the first support members is connected by one of the short shafts at one of its ends to one of the toolboxes and is connected by another one of the shorts shaft at its second end to another one of the toolboxes, wherein each of the toolboxes has a rotational capability with regard to the pair of first support members.

According to still further features of the described embodiment of the present invention, the portable foldable multi carriage device further includes: at least one side wheel, mounted practically on an end of one of the second support members.

According to still further features of the described embodiment of the present invention, one toolbox, one pair of first support members, and one pair of second support members, are defining one tier of the portable foldable multi carriage device, and wherein the portable foldable multi carriage device comprises at least two of tiers, mounted one above the other.

According to still further features of the described embodiment of the present invention, the portable foldable multi carriage device, further includes: a carrying handle mounted on one of the toolboxes; at least one first lock mounted on one of the toolboxes; and at least one flat spring mounted on one of the first support member.

According to still further features of the described embodiment of the present invention, the first support member is divided into two first support member halves, the two first support member halves are mounted inside a first telescopic support member, and wherein the second support member is divided into two second support member halves, wherein the two second support member halves are mounted inside a second telescopic support member.

According to still further features of the described embodiment of the present invention, the portable foldable multi carriage device further includes: at least one stretching spring, having two ends, wherein one of the stretching spring ends is disposed on an edge of a bottom of one of the toolboxes, wherein a second end of the stretching spring is disposed on a long shaft, and wherein the long shaft is disposed on two ends, of two of the second support members.

According to still further features of the described embodiment of the present invention, the portable foldable multi carriage device further includes: a cog track, disposed on the bottom; and a cogwheel, disposed on a long shaft.

According to still further features of the described embodiment of the present invention, the portable foldable multi carriage device further includes: a rotational handle, mounted on the long shaft, on which the cogwheel is mounted.

According to still further features of the described embodiment of the present invention, the portable foldable multi carriage device further includes: a ratchet mechanism disposed on the long shaft, which the cogwheel is mounted on, and on a second support member.

According to still further features of the described embodiment of the present invention, the center of rotation is practically located at a center of each of the first support member.

According to another features of the described embodiment of the present invention, the center of rotation is practically located closer to one end than to another end of each of the first support member.

According to another features of the described embodiment of the present invention, the portable foldable multi carriage further includes: a telescopic walls box mounted inside said toolbox.

According to another features of the described embodiment of the present invention, the portable foldable multi carriage further includes: two grooves in two opposite walls of said toolbox, wherein in each of said grooves there is mounted one of said side wheel.

According to a features of a second embodiment of the present invention the portable foldable multi carriage device further includes: a pair of third support members and at least one short shaft, wherein the short shaft is mounted on one of the second support members and is mounted on at least one of the first support members, and wherein the second support member and the first support member, have a rotational capability with regard to each other and wherein the short shaft is the center of the rotation.

According to still further features of the second described embodiment of the present invention, one pair of third support members, one pair of first support members, and one pair of second support members, are defining one tier of the portable foldable multi carriage device, and wherein the portable foldable multi carriage device comprises at least two of the tiers, mounted one above the other.

According to still further features of the second described embodiment of the present invention, the portable foldable multi carriage device further includes: at least one horizontal shelf, mounted on one of the long shaft; and at least one vertical shelf mounted on another one of the long shafts, wherein the horizontal shelf and the vertical shelf, has a rotational capability with regard to each other.

According to still further features of the second described embodiment of the present invention, the horizontal shelf has at least one pin, wherein the vertical shelf has at least one locking hole, and wherein the pin and the locking hole are compatible and enable a locking the horizontal shelf and the vertical shelf to each other.

According to still further features of the second described embodiment of the present invention, the vertical shelf is practically thinner than the horizontal shelf.

According to still further features of the second described embodiment of the present invention the portable foldable multi carriage device further includes: at least one main diagonal shelf, mounted on the pair of first support member; and at least one secondary diagonal shelf mounted on one of the long shafts.

According to still further features of the second described embodiment of the present invention the portable foldable multi carriage device of claim 16, further including: at least one second lock mounted on one of the second support member.

According to still further features of the second described embodiment of the present invention, the portable foldable multi carriage device further includes: two first base members, wherein each of the first base members has two ends, wherein each of the first base members is mounted practically at each of the ends on a long shaft; and two second base members, wherein each of the second base members has two ends, wherein each of the second base members is mounted practically at one of the ends to one of the long shaft, wherein each of the second base members has an opening, practically close to the other one of the ends, and wherein the first base members, the second base members, has a rotational capability with regard to each other.

Additional objects and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIG. 1 of the prior art a side view schematic illustration of two typical multi carriage devices, serving as toolboxes.

FIG. 2 is an isometric schematic illustration of an illustrative, exemplary embodiment of a portable foldable multi carriage device, having two pairs of support members between every two adjacent carriage tiers, according to the present invention, in closed mode.

FIG. 3a is an isometric schematic illustration of an illustrative, exemplary embodiment of a portable foldable multi carriage device, having two pairs of support members between every two adjacent tiers of carriages, according to the present invention, in a state of one open tier.

FIG. 3b is an isometric schematic illustration of an illustrative, exemplary embodiment of one tier of a portable foldable multi carriage device, having telescopic walls, according to the present invention, in a state of one open tier.

FIG. 3c is an isometric schematic illustration of an illustrative, exemplary embodiment of telescopic support member of a portable foldable multi carriage device, having two pairs of support members between every two adjacent tiers of carriages, according to the present invention.

FIG. 4 is an isometric schematic illustration of an illustrative, exemplary embodiment of a portable foldable multi carriage device, having two pairs of support members between every two adjacent tiers of carriages, according to the present invention, in a state of two open tiers.

FIG. 5a is an isometric schematic illustration of an illustrative, exemplary embodiment of a portable foldable multi carriage device, having two pairs of support members between every two tiers of adjacent carriages, according to the present invention, in a state of a partially open top tier.

FIG. 5b is a top schematic illustration of an illustrative, exemplary embodiment of a toolbox, having two opening handles, according to the present invention.

FIG. 6a is a side schematic illustration of an illustrative, exemplary embodiment of a portable foldable multi carriage device, having two pairs of support members between every two adjacent carriage tiers, according to the present invention, with two open tiers.

FIG. 6b is a geometrical side view schematic illustration of a portable foldable multi carriage device, having two pairs of support members between every two adjacent carriage tiers, according to the present invention, with each first support member divided into two different length segments.

FIG. 6c is a geometrical side view schematic illustration of a portable foldable multi carriage device, having two pairs of support members between every two adjacent carriage tiers, according to the present invention, with each first support member divided into two equal lengths.

FIG. 7a is an isometric schematic illustration of an illustrative, exemplary embodiment of a top tier of a portable foldable multi carriage device, having two pairs of support members between every two adjacent carriage tiers, according to the present invention, with the option of adding stretching springs.

FIG. 7b is an isometric schematic illustration of an illustrative, exemplary embodiment of a top tier of a portable foldable multi carriage device, having two pairs of support members between every two adjacent carriage tiers, according to the present invention, with the optional addition of a rotational handle.

FIG. 7c is an isometric schematic illustration of an illustrative, exemplary embodiment of a ratchet device of a portable foldable multi carriage device, having two pairs of support members between every two adjacent carriage tiers, according to the present invention, with the optional addition of ratchet device.

FIG. 8a is an isometric schematic illustration of an illustrative, exemplary embodiment of a portable foldable multi carriage device, having three pairs of support members between every two adjacent carriage tiers, according to the present invention, in an open mode, without carriages.

FIG. 8b is an isometric schematic illustration of an illustrative, exemplary embodiment of a portable foldable multi carriage device, having three pairs of support members between every two adjacent carriage tiers, according to the present invention, in a transitional state, without carriages.

FIG. 9a is an isometric schematic illustration of an illustrative, exemplary embodiment of a portable foldable multi carriage device, having three pairs of support members between every two adjacent carriage tiers, according to the present invention, in a folded state with carriages.

FIG. 9b is an isometric schematic illustration of an illustrative, exemplary embodiment of a portable foldable multi carriage device, having three pairs of support members between every two adjacent carriage tiers, according to the present invention, in open mode, with carriages.

FIG. 10a is an isometric schematic illustration of an illustrative, exemplary embodiment of a horizontal shelf of a portable foldable multi carriage device, having three pairs of support members between every two adjacent carriage tiers, according to the present invention.

FIG. 10b is an isometric schematic illustration of an illustrative, exemplary embodiment of an horizontal shelf and vertical shelf, of a portable foldable multi carriage device, having three pairs of support members between every two adjacent carriage tiers, according to the present invention.

FIG. 10c is an isometric schematic illustration of an illustrative, exemplary embodiment of an horizontal shelf and vertical shelf, of a portable foldable multi carriage device, having three pairs of support members between every two adjacent carriage tiers according to the present invention, in a transitional state.

FIG. 10d is an isometric schematic illustration of an illustrative, exemplary embodiment of an horizontal shelf and vertical shelf, of a portable foldable multi carriage device, having three pairs of support members between every two adjacent tiers of carriages, according to the present invention, in open mode.

FIG. 11 is an isometric schematic illustration of an illustrative, exemplary embodiment of a portable foldable multi carriage device, having three pairs of support members between every two adjacent carriage tiers, according to the present invention, in open mode, with carriages.

FIG. 12 is an isometric schematic illustration of an illustrative, exemplary embodiment of a portable foldable multi carriage device, having three pairs of support members between every two adjacent carriage tiers, according to the present invention, serving as a hanging device.

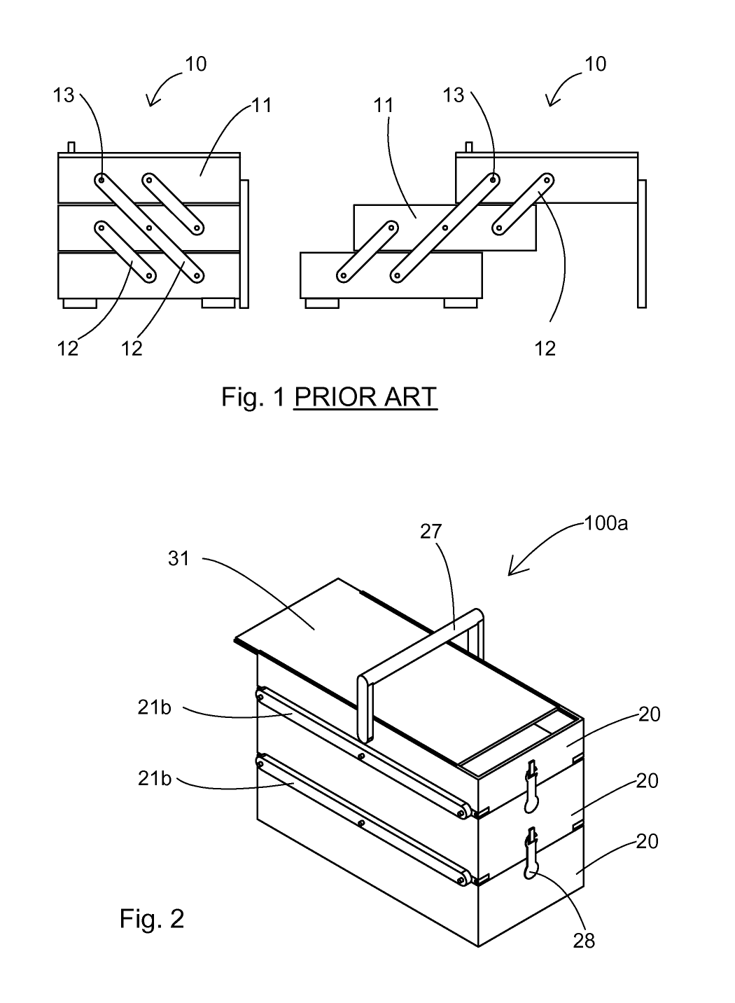

### DETAILED DESCRIPTION OF EMBODIMENTS

The present invention is of a portable foldable multi carriage device. The principles and operation of portable foldable multi carriage devices according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

The following list is a legend of the numbering of the application illustrations:
10 sewing kit
11 trays
12 parallel link members
13 pivots
18 tier
19 telescopic walls box
20 toolbox
20u topside
20l underside
21a first support member
21b second support member
21c third support member
22a first telescopic support member
22b second telescopic support member
23 locking pin
24 long shaft
25 short shaft
26 side wheel
27 carrying handle
28 first lock
29 opening handle
30 balancing member
31 cover
32 groove
33 flat spring
34 central wheel
35 stretching spring
36 cogwheel
37 cog track
38 rotational handle
39 ratchet mechanism
40 first base member
41 second base member
42 opening
43 second lock
44 horizontal shelf
45 vertical shelf
46 main diagonal shelf
47 secondary diagonal shelf
48 pin
49 locking hole
50 lamp
51 post
100a portable foldable multi carriage device, having two pairs of support members between every two adjacent carriage tiers
100b portable foldable multi carriages device, having three pairs of support members between every two adjacent carriage tiers

Referring now to the drawings, FIG. 2 is an isometric schematic illustration of an illustrative, exemplary embodiment of a portable foldable multi carriage device 100a, having two pairs of support members between every two adjacent carriage tiers, according to the present invention, in closed mode.

The portable foldable multi carriage device 100a shown in the present illustration includes three tiers of toolboxes 20, when the bottom two are at the same height, while the top one is of a smaller height, and has an optional cover 31, shown slightly open, and an additionally optional carrying handle 27.

The illustration shows second support members 21b, whose purpose will be explained in the following, between every two tiers. The illustration also shows first locks 28, which can be optionally installed on the sides of toolboxes 20, and are designed to prevent the portable foldable multi carriage device 100a from opening when being carried by a hand holding carrying handle 27.

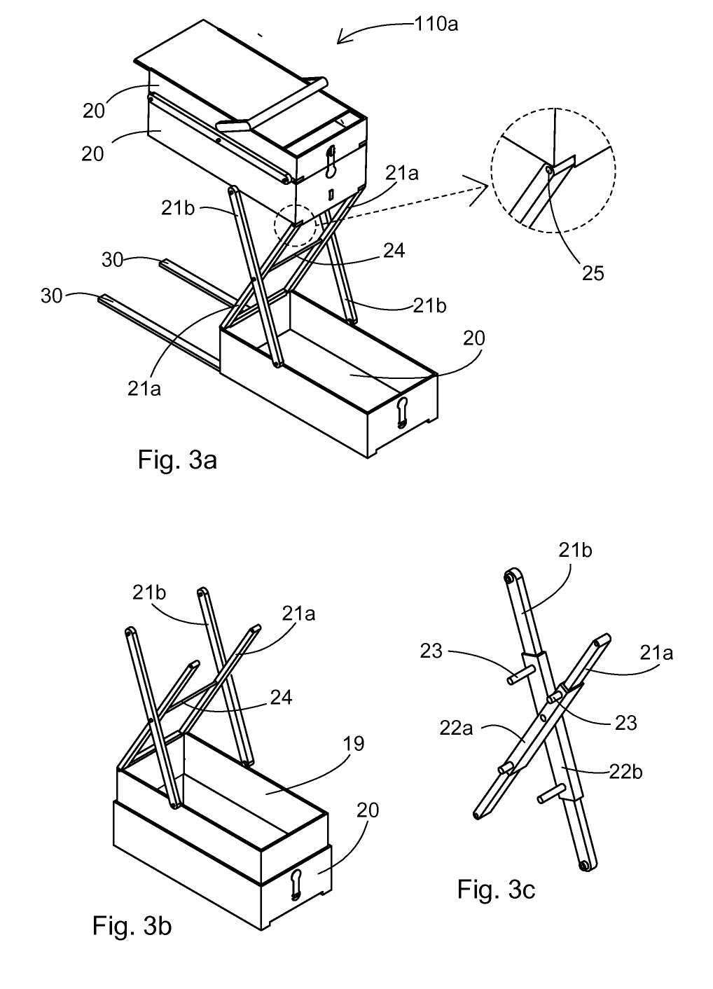

FIG. 3a is an isometric schematic illustration of an illustrative, exemplary embodiment of a portable foldable multi carriage device 100a, having two pairs of support members between every two adjacent tiers of carriages, according to the present invention, in a state of one open tier.

Each first support member 21a is connected at each of its ends by means of a shaft to toolbox 20.

One such connection is magnified in the circle on the right side of the illustration, which shows the tip of a short shaft 25. Through both centers of each pair of first support members 21a passes a long shaft 24, which also passes through each pair of second support members 21b, though not necessarily through the center. At the end of each second support member 21b is a wheel or other sliding mechanism, as will be described in the following.

A second support member 21b is characterized with both of its ends being free.

As used herein the specification and in the claims section that follows, the term “free support member end” and the like refer to ends that are connected neither to any carriage nor to any other support member not of the same pair, and at most will have a side wheel on a shaft or some other sliding device, engaged within a groove of a carriage, such as a toolbox.

At one end of the bottom toolbox 20, there can be a support mechanism, of various types including the type presented for example in the present illustration, in which the support mechanism includes two retractable balancing members 30 disposed on the underside of the bottom toolbox 20.

FIG. 3b is an isometric schematic illustration of an illustrative, exemplary embodiment of one tier of a portable foldable multi carriage device, having telescopic walls box 19, according to the present invention, in a state of one open tier. A telescopic walls box 19 can be added into the toolbox 20 when the portable foldable multi carriage device (100a), having two pairs of support members between every two adjacent carriage tiers, is folded, and it can be pulled upwards as shown in the present illustration thus increasing the storage volume.

The telescopic walls box 19 can be kept pulled out by means of pins, not shown in the illustration, by means of friction between walls, or by any other means.

FIG. 3c is an isometric schematic illustration of an illustrative, exemplary embodiment of telescopic support member of a portable foldable multi carriage device 100a, having two pairs of support members between every two adjacent tiers of carriages, according to the present invention.

The normal maximum gap that can be achieved between two adjacent tiers is limited as a result of the length of the relevant first support member 21a, which is practically no longer than the length dimension of toolbox 20.

To achieve a gap between two tiers which is larger than the length of first support member 21a, portable foldable multi carriage device 100a has a first support member 21a and a second support member 21b, which are halved and respectively disposed within a first telescopic support member 22a and a second telescopic support member 22b so that their lengths can be adjusted when creating the gap between two adjacent toolboxes 20 and fixed by means of locking pins 23.

FIG. 4 is an isometric schematic illustration of an illustrative, exemplary embodiment of a portable foldable multi carriage device 100a, having two pairs of support members between every two adjacent tiers of carriages, according to the present invention, in a state of two open tiers 18. Each tier 18 also includes, one toolbox 20. The circle on the right side of the illustration shows a magnified side wheel 26, resting on the topside 20u of tool-box 20.

Side wheel 26 is also installed near the second tip of the second support member 21b, and it takes part in supporting the toolbox 20 above it, by contact with the toolbox's underside 20l.

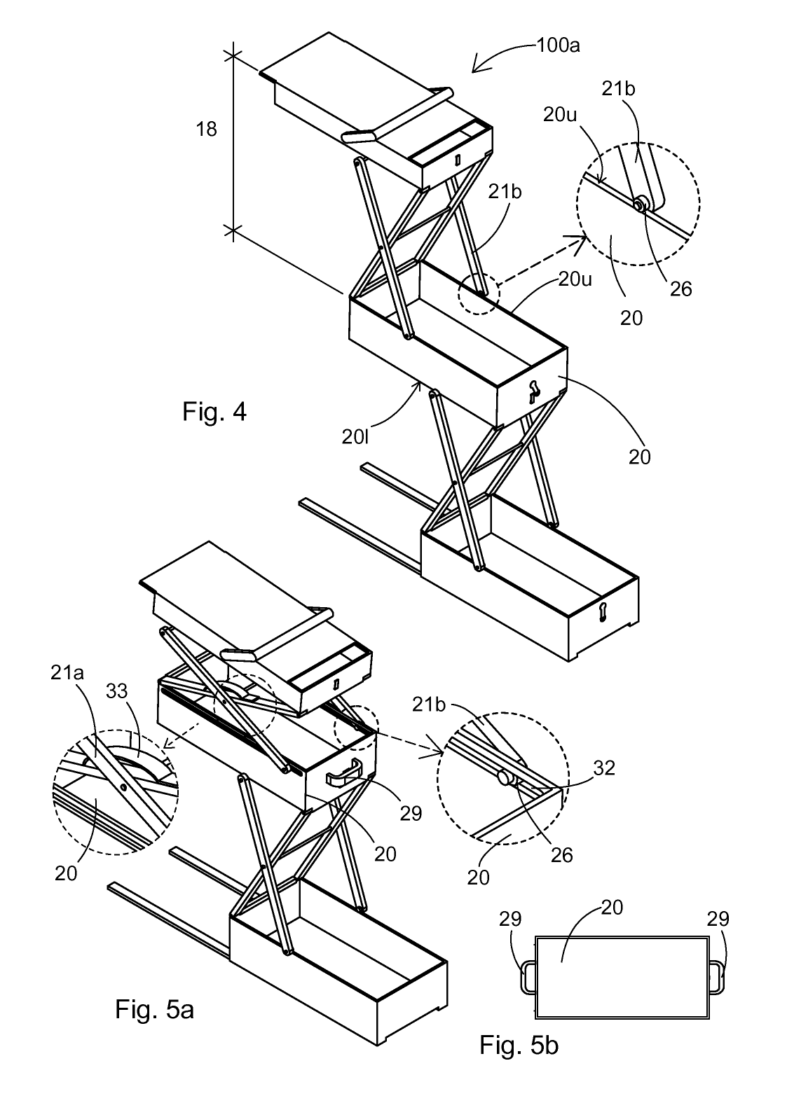

FIG. 5a is an isometric schematic illustration of an illustrative, exemplary embodiment of a portable foldable multi carriage device 100a, having two pairs of support members between every two tiers of adjacent carriages, according to the present invention, in a state of a partially open top tier. The window on the right side of the present illustration shows a side wheel 26 within groove 32, which is disposed near the topside 20u of toolbox 20, as another option.

Groove 32 can also be disposed next to the underside 20l of toolbox 20, and can contain an additional side wheel 26.

The circle on the left side shows a magnification of a flat spring 33, which can be connected at one of its ends to first support member 21a and serves both to assist in providing pushing force when opening as well as to soften the impact that may be occur between two adjacent toolboxes 20 when closing.

There is an optional opening handle 29, mounted on one wall of one of the toolboxes 20, which serves as a manual grasping point when opening. Additional opening handles 29 can be mounted on additional walls.

FIG. 5b is a top schematic illustration of an illustrative, exemplary embodiment of a toolbox 20, having two opening handles 19, according to the present invention.

According to the present invention, an opening handle 19 can be assembled to any of the walls of toolbox 20 and be positioned and quantified such that the opening is optimally efficient for the structure of the portable foldable multi carriage device.

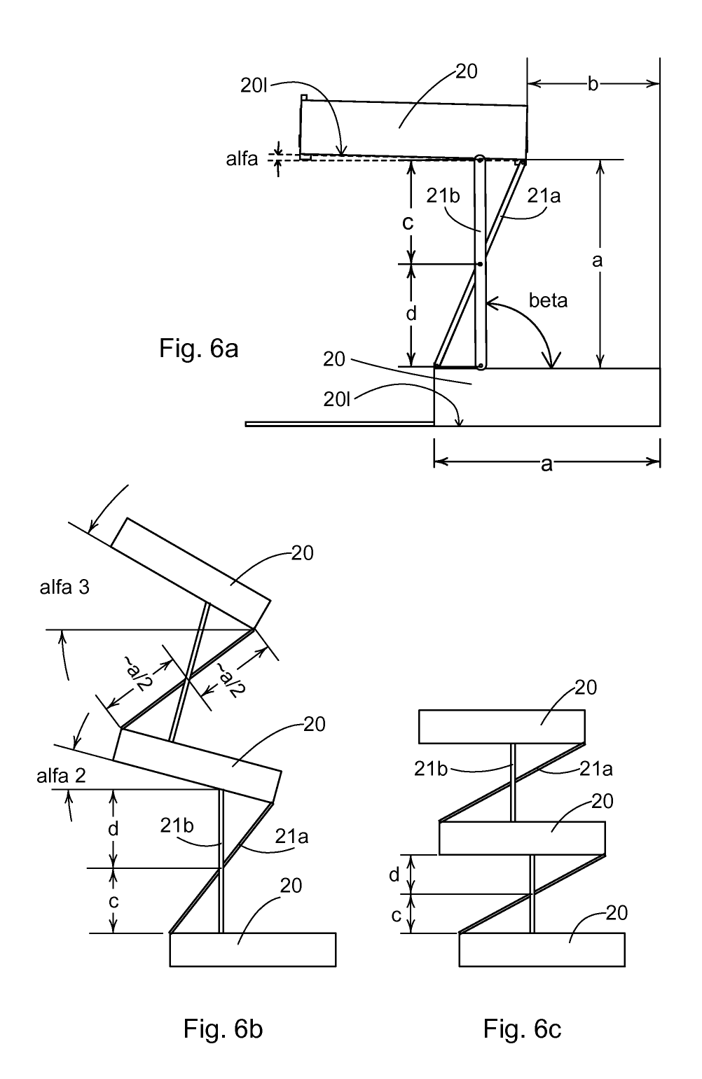

FIG. 6a is a side schematic illustration of an illustrative, exemplary embodiment of a portable foldable multi carriage device 100a, having two pairs of support members between every two adjacent carriage tiers, according to the present invention, with two open tiers. In the present illustration the angle between the lower toolbox 20 and the second support member 21b, which is marked as beta, is 90 degrees, and the gap achieved between both toolboxes 20 is at its maximum possible. This maximum possible distance, is the shortest distance of the state shown in the illustration, between both toolboxes 20 practically, for small alpha angle and small side radius wheel 26, equals the distance between the shafts on both ends of the first support member 21a, practically equals the length of the toolboxes 20, and is marked as a.

In the present illustration, the joint rotation shaft of the first support member 21a and the second support member 21b divides the first support member 21a into two equal lengths and divides the second support member 21b into two parts of uneven lengths, a lower part marked as d and a longer upper part marked as c. As a result, when the underside of the bottom toolbox 20 is on a horizontal plane, the underside of the toolbox 20 one tier above it is at an angle marked as alpha relative to the horizon, and there is a horizontal deviation between both toolboxes 20, marked as b. The angle alpha can also be measured between two undersides 20l.

FIG. 6b is a geometrical side view schematic illustration of a portable foldable multi carriage device 100a, having two pairs of support members between every two adjacent carriage tiers, according to the present invention, with each second support member 21b divided into two different length segments, namely c≠d while the length of each first support member 21a is divided into two equal length segments, namely the length of each segment is practically a/2. As a result, the angle alpha between every toolbox 20 and the horizon, is larger the higher the tier. These alpha angles can be controlled according to the purpose requirements, by determining the lengths and divisions of every pair of second support members 21b.

FIG. 6c is a geometrical side view schematic illustration of a portable foldable multi carriage device 100a, having two pairs of support members between every two adjacent carriage tiers, according to the present invention, with each second support member 21b divided into two equal lengths, namely d=c. As a result, in any open state all undersides of the toolboxes 20 remain parallel. This geometrical description is accurate on the condition that the topside 20u of each toolbox 20 is parallel to its underside 20l.

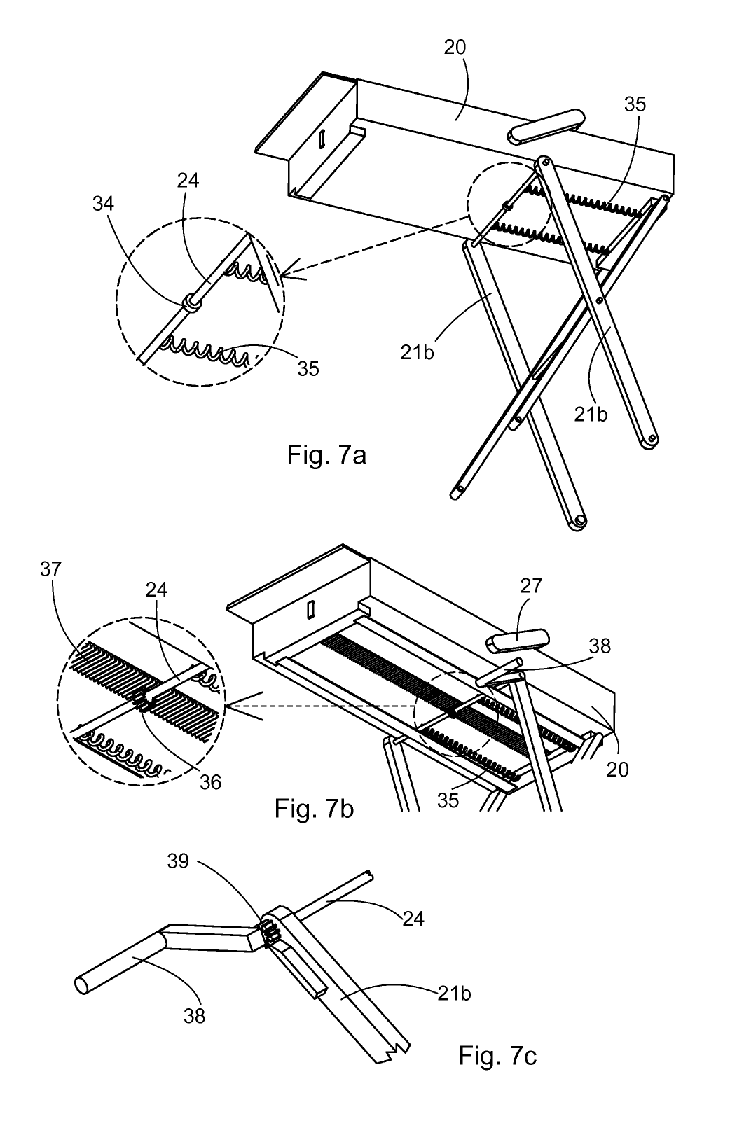

FIG. 7a is an isometric schematic illustration of an illustrative, exemplary embodiment of a top tier of a portable foldable multi carriage device 100a, having two pairs of support members between every two adjacent carriage tiers, according to the present invention. This illustration shows the option of adding stretching springs 35 to facilitate opening of the portable foldable multi carriage device 100a.

The stretching springs 35 are installed underneath tool-box 20. Each stretching spring 35 is connected at one end to the underside of a tool-box 20 and at its other end, as magnified in the circle on the left side of the illustration, to a long shaft 24, which connects the ends of a pair of second support members 21b. Furthermore, additional support can be gained by adding one or more wheels, such as a central wheel 34, mounted on a long shaft 24.

FIG. 7b is an isometric schematic illustration of an illustrative, exemplary embodiment of a top tier of a portable foldable multi carriage device 100a, having two pairs of support members between every two adjacent carriage tiers, according to the present invention. This illustration shows the optional addition of a rotational handle 38, in this specific case even in addition to stretching springs 35, to facilitate opening of the portable foldable multi carriage device 100a. The magnified circle on the left side shows that the underside of tool-box 20, in this case the topmost one, has an attached cog track 37, and the long shaft 24 has a corresponding mounted cogwheel 36. One end of long shaft 24 is attached to the rotational handle 38, so that manual rotation of the handle rotates the long shaft 24, which in turn rotates the cogwheel 36, moving it along the cog track 37.

FIG. 7c is an isometric schematic illustration of an illustrative, exemplary embodiment of a ratchet mechanism 39 of a portable foldable multi carriage device 100a, having two pairs of support members between every two adjacent carriage tiers, according to the present invention. To prevent unwanted closing of portable foldable multi carriage device 100a, a ratchet mechanism 39 can be mounted on the long shaft 24 and on the corresponding second support member 21b.

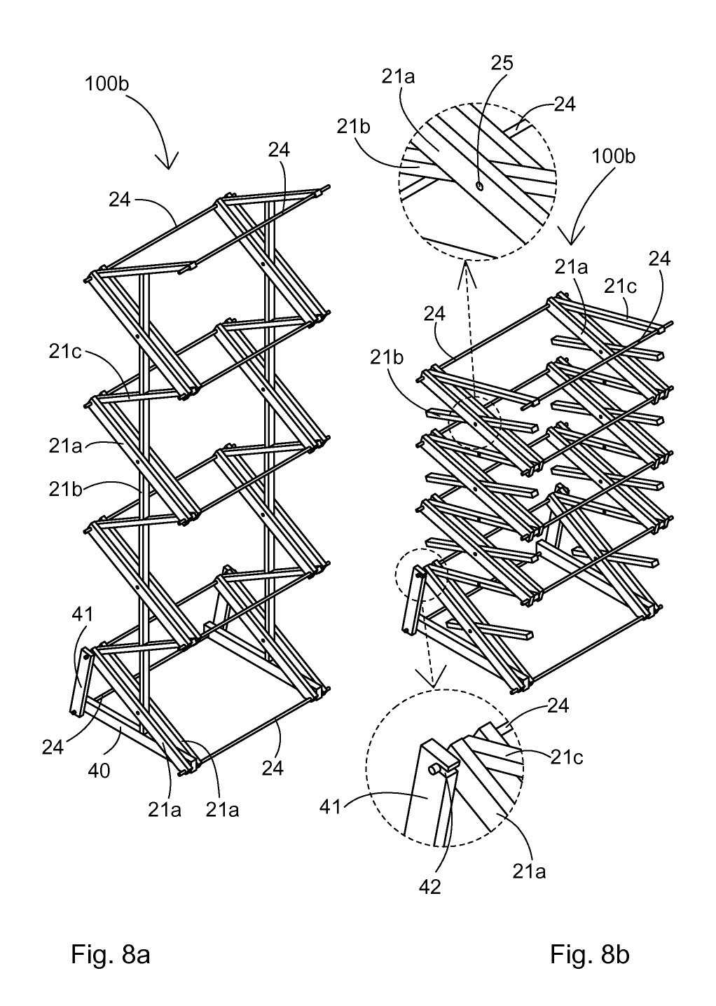

FIG. 8a is an isometric schematic illustration of an illustrative, exemplary embodiment of a portable foldable multi carriage device 100b, having three pairs of support members between every two adjacent carriage tiers, according to the present invention, in an open mode, without carriages. In this configuration, the third support member 21c and the first support member 21a are connected at their edges by means of a long shaft 24 and the first support member 21a is connected to a second support member 21b by means of a short shaft 25.

In order to achieve increased strength and structural stability, a parallel and corresponding additional first support member 21a can be added to each first support member 21a, as shown in the present illustration.

The lower end of the bottom first support member 21a is connected, by means of a long shaft 24, to a first base member 40, which is connected, by means of another long shaft 24, to a second base member 41, which is connected by means of yet another long shaft 24 to the first support member 21a and to a third support member 21c.

FIG. 8b is an isometric schematic illustration of an illustrative, exemplary embodiment of a portable foldable multi carriage device 100b, having three pairs of support members between every two adjacent carriage tiers, according to the present invention, in a transitional state, without carriages. The illustration shows that the second support members 21b ends are free.

The upper circle shows a magnification of the connection by means of a short shaft 25. The lower circle shows a magnification of the option of disconnecting one end of the second base member 41 from a long shaft 24 by means of opening 42. This option enables compact folding, also of the bottom part of the portable foldable multi carriage device 100b.

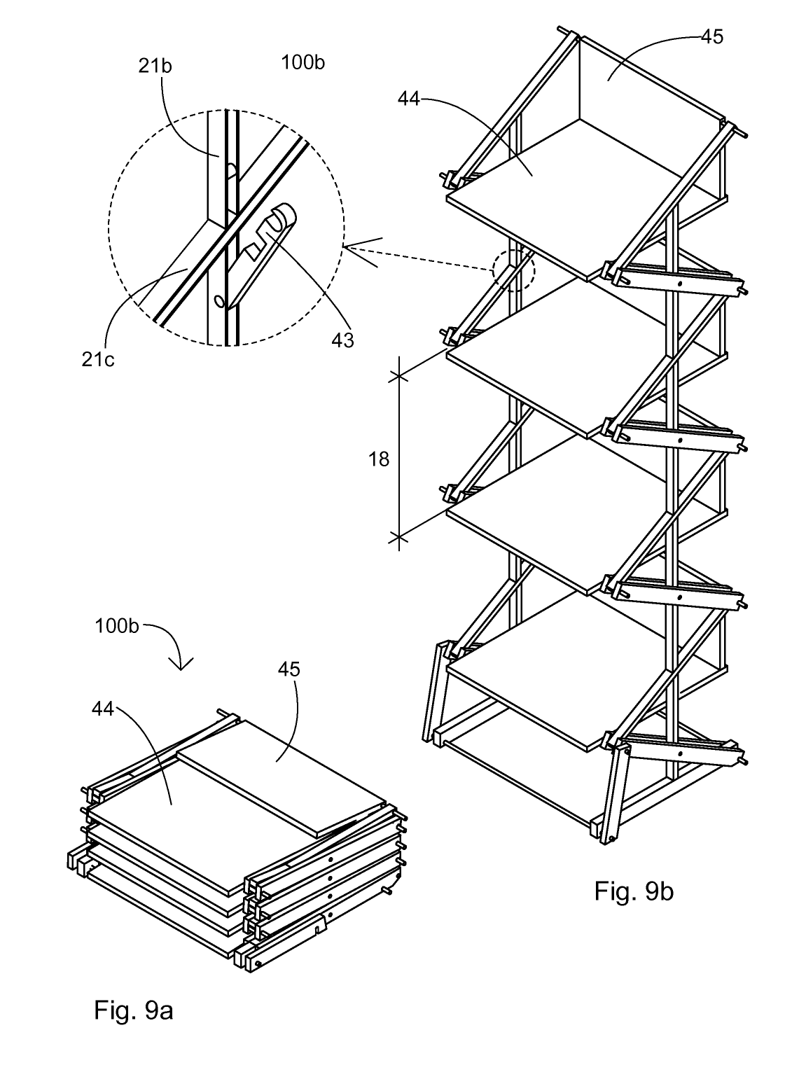

FIG. 9a is an isometric schematic illustration of an illustrative, exemplary embodiment of a portable foldable multi carriage device 100b, having three pairs of support members between every two adjacent carriage tiers, according to the present invention, in a folded state with carriages. Every tier has one horizontal shelf 44 and one vertical shelf 45, which is in the present state also practically horizontal.

FIG. 9b is an isometric schematic illustration of an illustrative, exemplary embodiment of a portable foldable multi carriage device 100b, having three pairs of support members between every two adjacent carriage tiers, according to the present invention, in open mode, with carriages. Every tier has one horizontal shelf 44 and one vertical shelf 45.

The illustration shows a tier 18 which also includes one horizontal shelf 44 and one vertical shelf 45.

The circle on the left side shows an option for locking third support member 21c with two second support members 21b, which has a U-shaped cross section, by means of second lock 43.

The transitions from open mode, as shown in the previous illustration, to open mode, as shown in the present illustration, and back can be done with the portable foldable multi carriage device 100b lying on the ground.

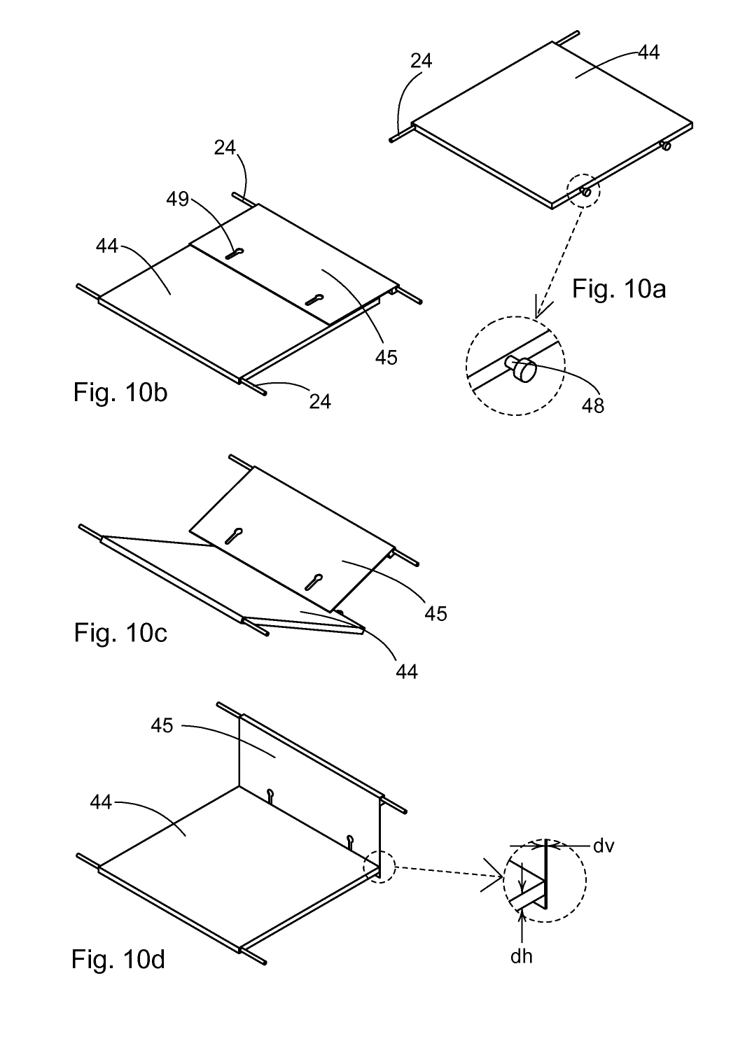

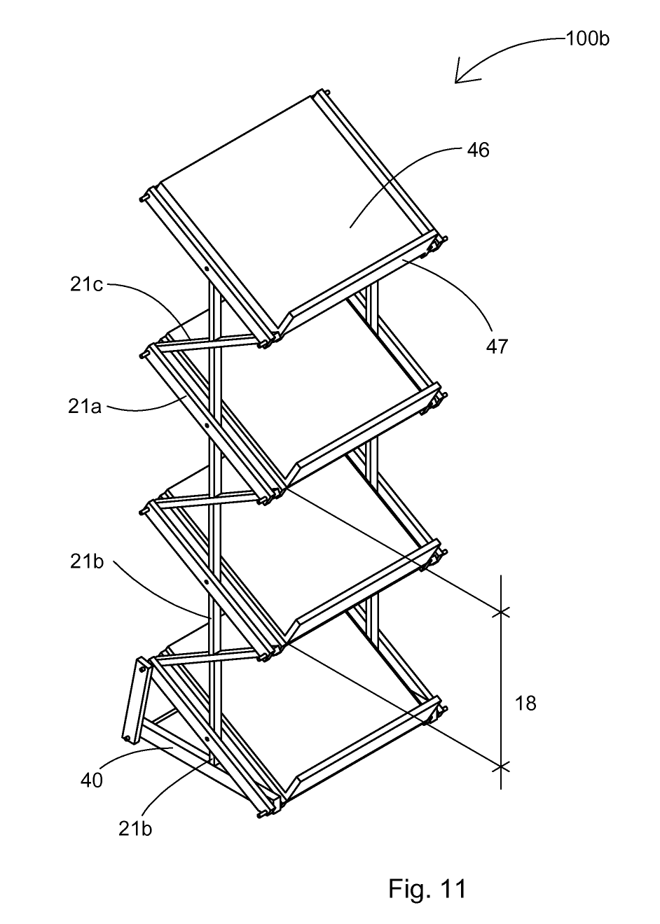

FIG. 10a is an isometric schematic illustration of an illustrative, exemplary embodiment of a horizontal shelf 44 of a portable foldable multi carriage device 100b, having three pairs of support members between every two adjacent carriage tiers, according to the present invention.

The horizontal shelf 44 is connected at one end to long shaft 24, while on the opposite end is at least one pin 48, magnified in the circle underneath. Pin 48 serves to connect and disconnect horizontal shelf 44 and a vertical shelf not shown in the present illustration.

FIG. 10b is an isometric schematic illustration of an illustrative, exemplary embodiment of an horizontal shelf 44 and vertical shelf 45, of a portable foldable multi carriage device 100b, having three pairs of support members between every two adjacent carriage tiers, according to the present invention. Vertical shelf 45 is connected on one end to another long shaft 24. Near its opposite end, is engraved at least one locking hole 49, which during locking is engaged with pin 48. In the present illustration the horizontal shelf 44 and vertical shelf 45 are in folded mode, with the vertical shelf 45 resting upon the horizontal shelf 44. In order to achieve compact folding, the vertical shelf 45 can be made of a strong material which is thin relative to the thickness of the horizontal shelf 44.

FIG. 10c is an isometric schematic illustration of an illustrative, exemplary embodiment of an horizontal shelf 44 and vertical shelf 45, of a portable foldable multi carriage device 100b, having three pairs of support members between every two adjacent carriage tiers according to the present invention.

The horizontal shelf 44 and vertical shelf 45 are in a transitional state.

FIG. 10d is an isometric schematic illustration of an illustrative, exemplary embodiment of an horizontal shelf 44 and vertical shelf 45, of a portable foldable multi carriage device 100b, having three pairs of support members between every two adjacent tiers of carriages, according to the present invention.

The horizontal shelf 44 and the vertical shelf 45 are in open mode, locked to each other by engagement of at least one pin (48), not shown in the present illustration, with locking hole 49. As shown in the circle on the right side, the thickness of the vertical shelf 45, which is marked dv, can be small relative to the thickness of the horizontal shelf 44, which is marked dh.

FIG. 11 is an isometric schematic illustration of an illustrative, exemplary embodiment of a portable foldable multi carriage device 100b, having three pairs of support members between every two adjacent carriage tiers, according to the present invention, in open mode, with carriages. In the configuration shown in the present illustration, the carriages are main diagonal shelves 46 and secondary diagonal shelves 47. Each main diagonal shelf 46 is attached to a second support member 21b. Each secondary diagonal shelf 47 is practically perpendicular to main diagonal shelf 46, attached to its bottom end.

The illustration shows a tier 18, which also includes one main diagonal shelf 46, and one secondary diagonal shelf 47.

The lower part of each one of the second most lower support members 21b is shorter than its upper part, for the purpose of geometrical compatibility with the location of a first base member 40, in open mode.

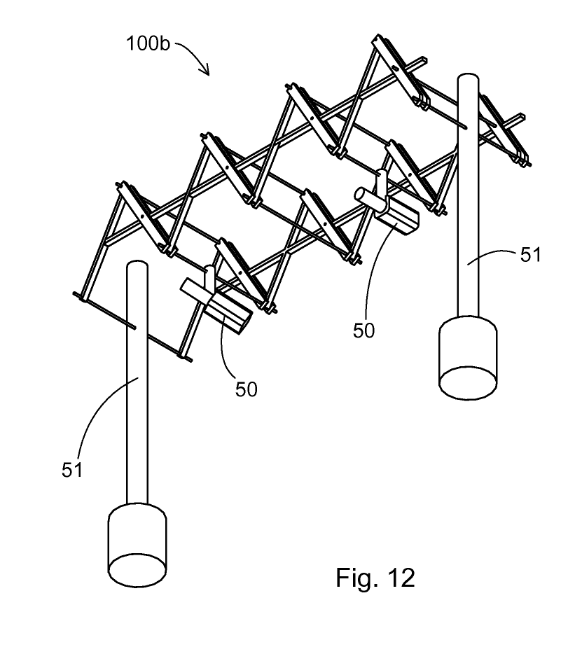

FIG. 12 is an isometric schematic illustration of an illustrative, exemplary embodiment of a portable foldable multi carriage device 100b, having three pairs of support members between every two adjacent carriage tiers, according to the present invention, serving as a hanging device. In this function, portable foldable multi carriage device 100b can be installed horizontally, for example, without shelves, between two posts 51, and loads such as lamps 50 can be placed upon it or hung from it for purposes such as lighting a theater stage.

Note that long shaft 24 and the short shaft 25 enable rotational movement between various items connected with them.

While the invention has been described with respect to a limited number of embodiments, it will be appreciated that many variations, modifications and other applications of the invention may be made.

What is claimed is:

1. A portable foldable multi carriage device comprising:
(a) a pair of first support members, wherein each of said first support members has two ends;
(b) a pair of second support members, wherein each of said second support members has two free ends; and
(c) a long shaft, wherein said pair of first support members is mounted on said long shaft, wherein said pair of second support members is mounted on said long shaft, having a rotational capability with regard to each other and wherein said long shaft is the center of the rotation, and wherein said portable foldable multi carriage device has a folded state and open state.

2. The portable foldable multi carriage device of claim 1, wherein said center of rotation is practically located at a center of each of said second support member.

3. The portable foldable multi carriage device of claim 2, further comprising:
(d) at least two toolboxes wherein each of said toolboxes has a topside and an underside; and
(e) at least four short shafts, wherein each of said first support members is connected by one of said short shafts at one of its ends to one of said toolboxes and is connected by another one of said shorts shaft at its second end to another one of said toolboxes, wherein each of said toolboxes has a rotational capability with regard to said pair of first support members.

4. The portable foldable multi carriage device of claim 3, further comprising:
(f) at least one side wheel, mounted practically on an end of one of said second support members.

5. The portable foldable multi carriage device of claim 4, wherein one toolbox, one pair of first support members, and one pair of second support members, are defining one tier of said portable foldable multi carriage device, and wherein said portable foldable multi carriage device comprises at least two tiers, mounted one above the other.

6. The portable foldable multi carriage device of claim 4, further comprising:
(g) a carrying handle mounted on one of said toolboxes;
(h) at least one first lock mounted on one of said toolboxes; and
(i) at least one flat spring mounted on one of said first support member.

7. The portable foldable multi carriage device of claim 6, wherein said first support member is divided into two first support member halves, said two first support member halves are mounted inside a first telescopic support member, and wherein said second support member is divided into two second support member halves, said two second support member halves are mounted inside a second telescopic support member.

8. The portable foldable multi carriage device of claim 4, further comprising:
(g) at least one stretching spring, having two ends, wherein one of said stretching spring ends is disposed on an edge of a bottom of one of said toolboxes, wherein a second end of said stretching spring is disposed on a long shaft, and wherein said long shaft is disposed on two ends, of two of said second support members.

9. The portable foldable multi carriage device of claim 8, further comprising:
(h) a cog track, disposed on said bottom; and
(i) a cogwheel, disposed on a long shaft.

10. The portable foldable multi carriage device of claim 9, further comprising:
(i) a rotational handle, mounted on said long shaft, on which said cogwheel is mounted.

11. The portable foldable multi carriage device of claim 10, further comprising:
(k) a ratchet mechanism disposed on said long shaft, on which said cogwheel is mounted, and on a second support member.

12. The portable foldable multi carriage device of claim 4, wherein said center of rotation is practically located at a center of each of said first support member.

13. The portable foldable multi carriage device of claim 4, wherein said center of rotation is practically located closer to one end than to another end of each of said first support member.

14. The portable foldable multi carriage device of claim 4, further comprising:
(g) a telescopic walls box mounted inside said toolbox.

15. The portable foldable multi carriage device of claim 4, further comprising:
(g) two grooves in two opposite walls of said toolbox, wherein in each of said grooves there is mounted one of said side wheel.

16. The portable foldable multi carriage device of claim 1, further comprising:
(d) a pair of third support members; and
(e) at least one short shaft, wherein said short shaft is mounted on one of said second support member and is mounted on at lest one of said first support member, and wherein said second support member and said first support member, have a rotational capability with regard to each other and wherein said short shaft is the center of the rotation.

17. The portable foldable multi carriage device of claim 16, wherein one pair of third support members, one pair of first support members, and one pair of second support members, are defining one tier of said portable foldable multi carriage device, and wherein said portable foldable multi carriage device comprises at least two of said tiers, mounted one above the other.

18. The portable foldable multi carriage device of claim 17, further comprising:
(f) at least one horizontal shelf, mounted on one of said long shaft; and
(g) at least one vertical shelf mounted on another one of said long shafts, wherein said horizontal shelf and said vertical shelf, have a rotational capability with regard to each other.

19. The portable foldable multi carriage device of claim 18, wherein said horizontal shelf has at least one pin, wherein said vertical shelf has at least one locking hole, and wherein said pin and said locking hole are compatible and enable a locking said horizontal shelf and said vertical shelf to each other.

20. The portable foldable multi carriage device of claim 19 wherein vertical shelf is practically thinner than said horizontal shelf.

21. The portable foldable multi carriage device of claim 16, further comprising:
(f) at least one main diagonal shelf, mounted on said pair of first support member; and
(g) at least one secondary diagonal shelf mounted on one of said long shafts.

22. The portable foldable multi carriage device of claim 16, further comprising:
(f) at least one second lock mounted on one of said second support member.

23. The portable foldable multi carriage device of claim 22, further comprising:
(g) two first base members, wherein each of said first base members has two ends, wherein each of said first base members is mounted practically at each of said ends on a long shaft; and
(h) two second base members, wherein each of said second base members has two ends, wherein each of said second base members is mounted practically at one of said ends to one of said long shafts, wherein each of said second base members has an opening, practically close to the other one of said ends, and wherein said first base members, said second base members, have a rotational capability with regard to each other.
